(19) United States
(12) Patent Application Publication
(10) Pub. No.: US 2026/0322296 A1
(43) Pub. Date: Oct. 15, 2026

(54) METHOD FOR CONTROLLING AN ELECTRICAL SYSTEM FOR AN ELECTRICALLY HYBRIDIZED GAS TURBINE ENGINE

(71) Applicant: SAFRAN, Paris (FR)

(72) Inventors: Guillaume François Daniel BIDAN, Moissy-Cramayel (FR); Anne Marie LIENHARDT, Moissy-Cramayel (FR); Florent Jean-Arnaud ROUGIER, Moissy-Cramayel (FR)

(73) Assignee: SAFRAN, Paris (FR)

(21) Appl. No.: 18/996,111

(22) PCT Filed: Jul. 19, 2023
(86) PCT No.: PCT/FR2023/051116

§ 371 Date: Jan. 17, 2025

(30) Foreign Application Priority Data
Jul. 29, 2022 (FR) FR2207834

(51) Int. Cl. H02P 9/10; B64D 41/00; F02C 7/32; F02C 9/00; H02P 101/25; H02P 101/30

(52) U.S. Cl. CPC H02P 9/105; B64D 41/00; F02C 7/32; F02C 9/00; H02P 2101/25; H02P 2101/30

(57) ABSTRACT

The present invention relates to a method for controlling an electrical system, comprising: processing a main command signal (IP) for commanding drawing of a mechanical power by the electrical system from an electrically hybridized turbomachine so as to extract from said signal a first frequency component (CF1) corresponding to a natural frequency of a first rotary body of the turbomachine and to generate a filtered first main signal (IF1) without the first frequency component (CF1); generating a first subsidiary command signal (CTRL_1) for commanding drawing of a mechanical power by the electrical system from the first rotary body based on the filtered first main signal (IF1); and generating a second subsidiary command signal (CTRL_2, CTRL_3) for commanding drawing of a power by the electrical system from an auxiliary power source based on the first frequency component (CF1).

### TECHNICAL FIELD

The present disclosure relates to the field of gas turbine engines, in particular aircraft engines. More precisely, the present disclosure relates to managing the power supply to electrical loads of an engine and/or an aircraft.

### PRIOR ART

An aircraft may comprise at least one engine, which may comprise at least two distinct rotary spools. In addition, each of the engine and the aircraft may comprise electrical loads and/or electrical power sources. An electrical system may connect together the loads, sources and engine, in order to allow electrical exchange between these different elements. In addition, the engine may comprise at least one electric machine connected to the rotary spools. Thus, at least one of the loads may be supplied with power by the electric machine which, for this purpose, draws a mechanical power from at least one of the rotary spools. Furthermore, at least one of the rotary spools may be assisted by drawing an electrical power from at least one source. In, that case, it is the electric machine that may be a source and then draws a mechanical power from the other of the rotary spools. The rotary spools thus stressed by drawing or injecting of mechanical power, may comprise natural modes, for example in torsion and/or in bending. Therefore, drawing or injecting mechanical power at frequencies close to these natural modes may cause all or part of the engine to resonate, which could damage it. On the other hand, avoiding the drawing or injecting of mechanical power from the rotary spools because of these natural modes may reduce the performance of the electrical system, and therefore of the engine or even of the aircraft.

### DISCLOSURE OF THE INVENTION

An object of the present disclosure is to improve the service life of an aircraft engine comprising an electrical load supplied by drawing mechanical power from the engine while ensuring the performance of the engine.

For this purpose, according to one aspect of the present disclosure, a method is proposed for controlling an electrical system comprising:
processing a main signal for commanding drawing of a mechanical power by the electrical system from an electrically hybridised gas turbine engine, so as to extract from it a first frequency component corresponding to a natural frequency of a first rotary spool of the gas turbine engine and to generate a filtered first main signal without the first frequency component;
generating a first subsidiary signal for commanding drawing of a mechanical power by the electrical system from the first rotary spool based on the filtered first main signal; and generating a second subsidiary signal for commanding drawing of a power by the electrical system from an auxiliary power source based on the first frequency component.

Advantageously, but optionally, the method may comprise at least one of the following features, taken alone or in any combination:
the auxiliary power source is a second rotary spool of the gas turbine engine and generating of the second subsidiary signal comprises filtering the first frequency component so as to extract from it a second frequency component corresponding to a natural frequency of the second rotary spool;
the auxiliary power source is a second rotary spool of the gas turbine engine, the method further comprising:
processing the main signal so as to extract from it a second frequency component corresponding to a natural frequency of the second rotary spool and to generate a second filtered main signal without the second frequency component;
processing the second filtered main signal according to an instruction for distributing drawing of mechanical power between the first rotary spool and the second rotary spool, so as to generate a filtered first intermediate signal for commanding drawing of a mechanical power by the electrical system from the first rotary spool and a filtered second intermediate signal for commanding drawing of a mechanical power by the electrical system from the second rotary spool;
wherein generating the first subsidiary signal is implemented based on the second frequency component and the filtered first intermediate signal; and
wherein generating the second subsidiary signal is implemented based on the filtered second intermediate signal;
the auxiliary power source is a second rotary spool of the gas turbine engine, the method further comprising the prior processing of the main signal so as to extract from it at least one third frequency component corresponding to a natural frequency common to the first rotary spool and to the second rotary spool and to generate a filtered main intermediate signal, wherein extracting at least one of the first frequency component and the second frequency component is implemented by processing the filtered main intermediate signal.
it further comprises generating a third subsidiary signal for commanding drawing of an electrical power by the electrical system from a DC source based on the third frequency component;
the auxiliary power source is a second rotary spool of the gas turbine engine, the method further comprising:
processing the main signal so as to extract from it a second frequency component corresponding to a natural frequency of the second rotary spool and to generate a second filtered main signal without the second frequency component;
generating a third subsidiary signal for commanding drawing of an electrical power by the electrical system from a DC source based on the first frequency component and the second frequency component;
it further comprises the prior processing of the main signal based on an instruction for distributing drawing power between the first rotary spool, the second rotary spool and the DC source, so as to generate a filtered first intermediate signal for commanding drawing of a mechanical power by the electrical system from the first rotary spool, a filtered second intermediate signal for commanding drawing of a mechanical power by the electrical system from the second rotary spool, and a filtered third intermediate signal for commanding drawing of an electrical power by the electrical system from the DC source, wherein extracting the first frequency component is implemented by processing the filtered first intermediate signal, extracting the second frequency component is implemented by processing the filtered second intermediate signal and generating the third subsidiary signal is implemented based on the filtered third intermediate signal; and
generating one of the first subsidiary signal and the second subsidiary signal is implemented based on a maximum authorised drawing threshold from one of the first rotary spool and the auxiliary power source.

According to another aspect, an electrical system is proposed comprising:
an electrical supply bus intended to be connected to at least one load and configured to supply electrical power to the load in the form of a DC signal;
a first AC generator intended to be connected to a first rotary spool of the electrically hybridised gas turbine engine in order to draw a mechanical power from the first rotary spool and transform it into electrical power able to be transferred to the bus;
a second AC generator intended to be connected to a second rotary spool of the gas turbine engine in order to draw a mechanical power from the second rotary spool and transform it into electrical power able to be transferred to the bus;
a first converter connecting the first AC generator to the bus and configured to regulate the bus voltage based on an electrical power supplied by the first AC generator;
a second converter connecting the second AC generator to the bus and configured to regulate the bus voltage based on an electrical power supplied by the second AC generator; and
a control device connected to the converters and configured to control the converters with a view to compensating a change in a bus voltage by implementing a method as described above.

According to another aspect, a gas turbine engine is proposed comprising:
an electrical system such as previously described;
a first rotary spool connected to the first generator; and
a second rotary spool connected to the second generator.

### DESCRIPTION OF THE FIGURES

Other features, aims and advantages will emerge from the following description, which is given purely by way of illustration and not being limiting and which should be read with reference to the attached drawings, in which:

FIG. 1 schematically illustrates an aircraft.

FIG. 2 is a schematic sectional view of a propulsion unit.

FIG. 3 schematically illustrates an electrical system.

FIG. 4 illustrates an embodiment of a control method according to the present disclosure.

FIG. 5 illustrates an embodiment of a control method according to the present disclosure.

FIG. 6 illustrates an embodiment of a control method according to the present disclosure.

FIG. 7 illustrates an embodiment of a control method according to the present disclosure.

FIG. 8 illustrates an embodiment of a control method according to the present disclosure.

FIG. 9 illustrates an embodiment of a control method according to the present disclosure.

FIG. 10 illustrates an embodiment of a control method according to the present disclosure.

In all the figures, similar elements have identical reference signs.

### DETAILED DESCRIPTION OF THE INVENTION

### Aircraft

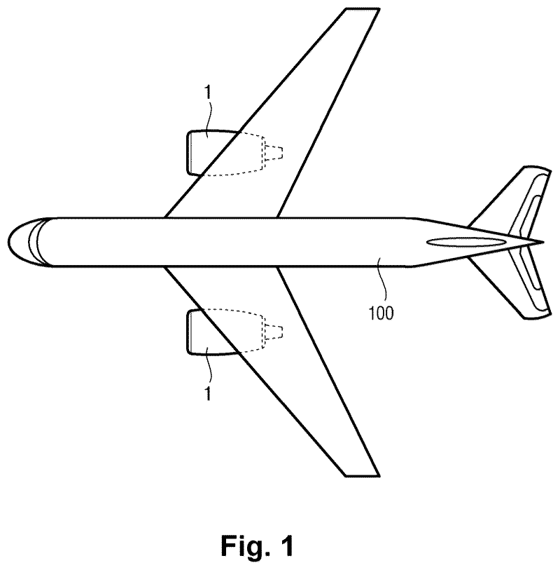

FIG. 1 illustrates an aircraft 100 comprising at least one propulsion unit 1, in this case two propulsion units 1. The aircraft 100 shown is a civil or military aeroplane, but could be any type of aircraft 100, such as a helicopter. The propulsion units 1 are attached and fixed on the aeroplane 100, each under a wing of the aeroplane 100, as can be seen in FIG. 1. This is however not limiting, since at least one propulsion unit 1 can also be mounted on the wing of the aeroplane or even at the rear of its fuselage.

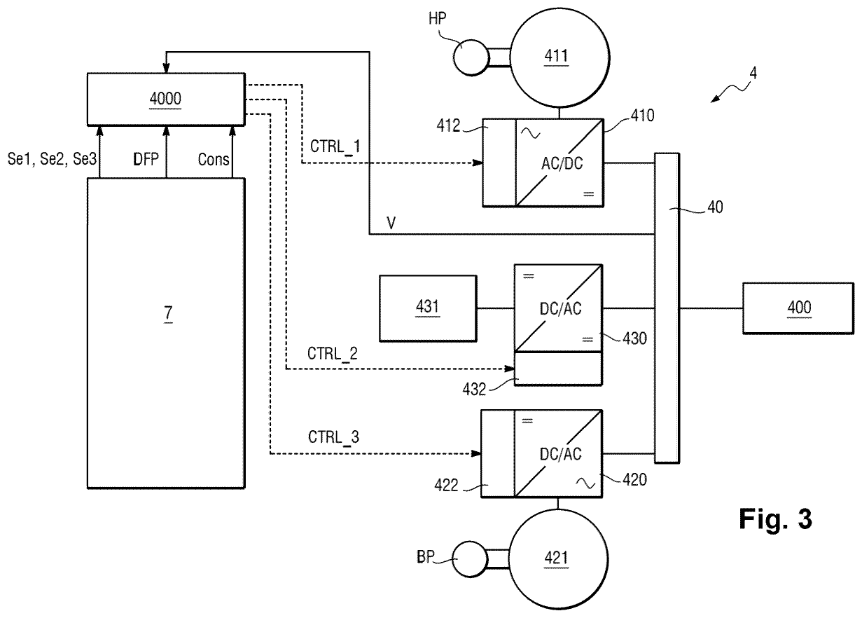

The aircraft 100 also comprises a plurality of electrical loads (or receivers) 400 shown in FIG. 3. Each electrical load 400 is a device supplied with electrical energy and able to be configured to transform the electrical energy which powers it into another form of energy, for example heat or mechanical energy. Non-limiting examples of electrical loads 400 of the aircraft 100 are: an electric motor, a heating and/or air-conditioning system, a compressor, etc. These electrical loads 400 can, in particular, ensure a certain number of functions, in flight as well as on the ground, such as pressurisation and/or illumination of the aircraft cabin 100, operation of the cockpit, etc.

In order to supply power to these electrical loads 400 with electrical energy, the aircraft 100 comprises a plurality of electrical networks, at least one of which is a DC network. Each electrical network typically comprises a set of electrical conductors, typically a set of wire(s) or bar(s) and/or an assembly of wire(s) and/or one (or more) printed track(s) and/or any apparatus which serves to conduct electricity. The DC network only allows the circulation of electrical energy in the form of a DC signal.

The electrical energy consumed by the electrical loads 400 can, at least partially, be produced by the engine 2 of the propulsion unit 1, described in more detail below, and more precisely by mechanical drawing from the rotary spools BP, HP of the engine 2.

### Propulsion Unit

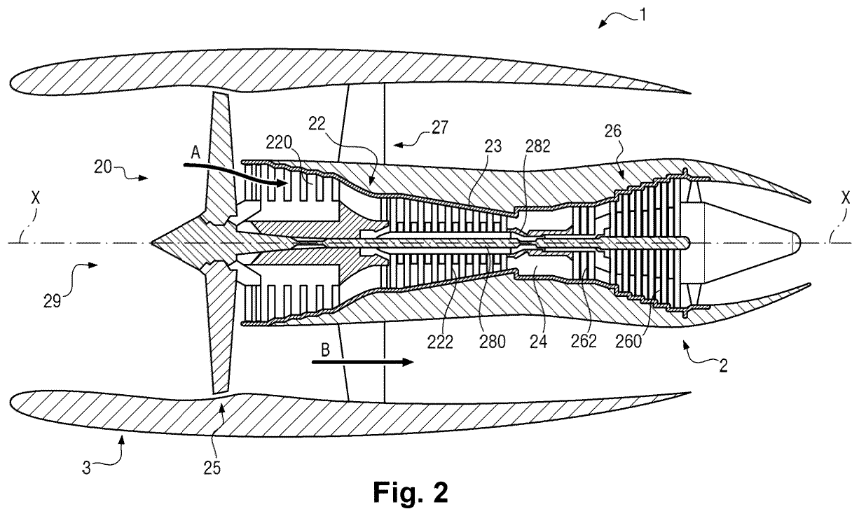

FIG. 2 illustrates a propulsion unit 1 extending along a longitudinal axis X-X, and comprising an engine 2, which is a gas turbine engine, and a nacelle 3 surrounding the engine 2.

The propulsion unit 1 is intended to be mounted on an aircraft 100, for example in the manner illustrated in FIG. 1. For this purpose, the propulsion unit 1 may comprise a mast (not shown) intended to connect the propulsion unit 1 to a part of the aircraft 100.

The engine 2 illustrated in FIG. 2 is a twin spool turbofan engine with direct drive of the fan 20. This is however not limiting since the engine 2 can have a different number of spools and/or flows, and/or be another type of turbojet engine, such as a turbojet engine with fan drive via a reducer, or a turboprop engine. Similarly, that which is described is applicable to all types of gas turbine engine, in other words all types of system enabling energy transfer between a rotating part and a fluid.

Unless otherwise specified, the terms “upstream” and “downstream” are used with reference to the overall direction of air flow through the propulsion unit 1 in operation. Similarly, an axial direction corresponds to the direction of the longitudinal axis X-X and a radial direction is a direction orthogonal to the longitudinal axis X-X and intersecting the longitudinal axis X-X. Furthermore, an axial plane is a plane containing the longitudinal axis X-X and a radial plane is a plane orthogonal to the longitudinal axis X-X. A circumference is meant to be a circle within a radial plane and the centre of which lies on the longitudinal axis X-X. A tangential or circumferential direction is a direction tangential to a circumference: it is orthogonal to the longitudinal axis X-X but does not pass through the longitudinal axis X-X. Finally, the adjectives “inner” (or “internal”) and “outer” (or “external”) are used with reference to a radial direction such that, in a radial direction, the inner part of an element is closer to the longitudinal axis X-X than the outer part of the same element.

As can be seen in FIG. 2, the engine 2 comprises, from upstream to downstream, a fan 20, a compression section 22 comprising a low-pressure compressor 220 and a high-pressure compressor 222, a combustion chamber 24, and an expansion section 26 comprising a high-pressure turbine 262 and a low-pressure turbine 260. Each of the low-pressure compressor 220, the high-pressure compressor 222, the high-pressure turbine 262 and the low-pressure turbine 260 comprises a rotor part and a stator part, the rotor part being able to be driven in rotation relative to the stator part, around the longitudinal axis X-X. The fan 20, the rotor part of the low-pressure compressor 220 and the rotor part of the low-pressure turbine 260 are connected to one another by a low-pressure shaft 280 extending along the longitudinal axis X-X, thus forming a low-pressure spool (spool BP) which is a first rotary spool. The rotor part of the high-pressure compressor 222 and the rotor part of the high-pressure turbine 262 are connected to one another by a high-pressure shaft 282 likewise extending along the longitudinal axis X-X, around the low-pressure shaft 280, thus forming a high-pressure spool (spool HP) which is a second rotary spool. As can be seen in FIG. 2, the compression section 22, the combustion chamber 24 and the expansion section 26 are surrounded by an engine casing 23, to which are connected the stator parts of the low-pressure compressor 220, of the high-pressure compressor 222, of the high-pressure turbine 262 and of the low-pressure turbine 260, while the fan 20 is surrounded by a fan casing 25. The engine casing 23 and the fan casing 25 are connected to each other by radially extending profile arms 27 forming outlet guide vanes (OGV), which are distributed circumferentially all around the longitudinal axis X-X. At least some of these arms 27 may be intended to be structural. The longitudinal axis X-X defines the axis of rotation for the fan 20, the rotor parts of the compression section 22 and the rotor parts of the expansion section 26, in other words for the spool BP and the spool HP, which are each able to be rotated around the longitudinal axis X-X with respect to the engine casing 23 and to the fan casing 25.

The nacelle 3 extends radially on the outside of the engine 2, all around the longitudinal axis X-X, so as to surround both the fan casing 25 and the engine casing 23, and to define, with a downstream part of the engine casing 23, a downstream part of a secondary duct B, the upstream part of the secondary duct B being defined by the fan casing 25 and an upstream part of the engine casing 23. The upstream part of the nacelle 3 further defines an air intake 29 via which the fan 20 sucks in the flow of air circulating through the propulsion unit 1. The nacelle 3 is integral with the fan casing 25 and attached and fixed to the aircraft 100 by means of the mast.

The engine 2 can also comprise at least one accessory gearbox (AGB) (not shown), typically housed in a cavity arranged within the nacelle 3. The accessory gearbox comprises a set of gears enabling rotation of a plurality of shafts around their own axes, accessories being mounted on these shafts in order to derive a useful mechanical power from their rotation. The set of gears is itself driven using a radial drive shaft (RDS), optionally connecting via a transfer box (not shown), the accessory gearbox to the at least one among the high-pressure spool HP and the low-pressure spool BP, typically being meshed with the at least one among the high-pressure shaft 282 and the low-pressure shaft 280. For this purpose, the radial drive shaft can extend inside a longitudinal cavity arranged within the one of the arms 27. In this way, a mechanical power is able to be drawn from the at least one among the high-pressure spool HP and the low-pressure spool BP to be delivered to the at least one of the accessories via the accessory gearbox.

The engine 2 can itself also comprise a plurality of electrical loads 400, such as a starter, variable geometry or de-icing systems, which must also be supplied with electrical energy. The power supply of at least some of these electrical loads 400 can be in the form of a DC signal, typically a DC voltage.

In operation, the fan 20 sucks in a flow of air, a portion of which, circulating within a primary duct A, is successively compressed in the compression section 22, ignited in the combustion chamber 24 and expanded in the expansion section 26 before being ejected from the engine 2. The primary duct A passes through the engine casing 23 from one side to the other. Another portion of the flow of air circulates in the secondary duct B which has an elongate annular shape surrounding the engine casing 23, the air sucked in by the fan 20 being straightened by the flow straighteners then ejected from the propulsion unit 1. In this way, the propulsion unit 1 generates a thrust. This thrust can, for example, be used for the benefit of the aircraft 100 on which the propulsion unit 1 is attached and fixed.

### Electrical System

FIG. 3 illustrates an electrical system 4 distributed between the propulsion unit 1 and the aircraft 100 for supplying electrical energy to the electrical loads 400 of the engine 2 and/or of the aircraft 100, typically by means of the DC network. The electrical system 4 can, in particular, produce the interface between the rotary spools BP, HP of the engine 2 and the electrical network of the aircraft 100. The electrical system is configured, in particular, to respond to the electrical power needs of the loads 400 of the aircraft 100 and/or of the engine 2 by mechanically drawing from the engine 2, in order to assist the starting and/or the operation in-flight of the engine 2 using electrical sources of the aircraft 100 and/or of the engine 2, and/or to ensure distribution of power between the rotary spools BP, HP of the engine 2. In other words, the engine 2 is electrically hybridised.

The electrical system 4 comprises an electrical bus 40, or electrical power supply bus 40, connected to at least one electrical load 400 of the aircraft 100 and/or of the engine 2, preferably an assembly of several loads 400 of the aircraft 100 and/or of the engine 2, the bus 40 being configured to supply an electrical power to the load 400 in the form of a DC signal in order, in particular, to respond to its power needs. In other words, the bus 40 is configured to allow a circulation of electrical energy in the form of a DC signal. The bus 40 may, for example, comprise a set of electrical conductors, typically a set of wire(s) or bar(s) and/or an assembly of wire(s) and/or one (or more) printed track(s) and/or any apparatus which serves to conduct electricity.

The electrical system 4 further comprises a plurality of electrical converters 410, 420, 430, each connected to a respective electrical source 411, 421, 431, in other words to an element configured to supply electrical power. The electrical sources 411, 421, 431 may be an AC generator 411, 421, and/or a DC source 431. The AC generator 411, 421 and the DC source 431 may belong to the engine 2, in other words be controlled at the same time as the engine 2, or even be controlled by the engine 2. In this case, these are the electrical sources 411, 421, 431 of the engine 2. Moreover, the DC source 431 is not necessarily located in the engine 2 and may, for example, be housed in the mast making it possible to fix the engine 2 to the aircraft 100. Alternatively, the DC source 431 belongs to the aircraft 100, in other words it is controlled at the same time as the aircraft 100. As can be seen in FIG. 3, the electrical system 4 can thus comprise a first converter 410 connected to a first AC generator 411, a second converter 420 connected to a second AC generator 421 and, optionally, a third converter 430 connected to a DC source 431. The third converter 430 and the DC source 431 are optional in the sense that in certain embodiments, they are absent or, in other embodiments, the DC source 431 is unavailable. On the other hand, each of the converters 410, 420, 430 is, as can be seen in FIG. 3, connected to the bus 40. In fact, at least one, if not each, of the converters 410, 420, 430 is configured to regulate the bus 40 voltage, on the basis of, in other words using, an electrical power supplied by the one or more electrical sources 411, 421, 431 to which the converters 410, 420, 430 are connected. The number and type of converters 410, 420, 430 and electrical sources 411, 421, 431 is, of course, not limiting.

The voltage regulation of the bus 40 is critical. More specifically, the change over time in the electrical voltage in the bus 40, during the operation of the electrical system 4, although it can temporarily vary around a given nominal value, must nevertheless remain within the limits of a margin, which is the guarantee that all of the elements connected to the bus 40 operate correctly. The margin defines the upper and lower limits of voltage excursion, as a function of time, during operation of the electrical system 4. The margin may comprise defined limits for normal and/or abnormal operating conditions, which limits enclose, symmetrically or otherwise, a nominal electrical voltage level of the bus 40. In a diagram (not shown) giving the change in the electrical voltage as a function of time, a limit of a margin is typically represented as a broken or unbroken line. Preferably, even if the limit does not initially define a constant electrical voltage value, in particular during the characteristic time for putting into operation (or starting) the electrical system 4 or during the time for establishing a permanent regime in the event of a power transient, it is common that the limit then defines a constant electrical voltage value, and this in order to guarantee the operating stability of the bus 40 and, therefore, of the electrical system 4. Such a margin may, for example, be defined in a standard relating to the quality of the electrical system 4 and/or of the DC network, but also be defined by specifications of an aircraft-type vehicle to which the electrical system 4 is connected, typically the requirements of the constructor of the aircraft 100 and/or of the engine 2 within which the electrical system 4 is incorporated.

On the other hand, the voltage regulation of the bus 40 makes it possible to respond to power demands by the loads 400 connected to the bus 40. Typically, when the quantity of power drawn by at least one load 400 on the bus 40 is greater than the quantity of power injected on the bus 40 by at least one converter 410, 420, 430, the bus voltage 40 drops significantly. Conversely, when the quantity of power injected by at least one converter 410, 420, 430 onto the bus 40 is greater than the quantity of power drawn from the bus 40 by at least one load 400, the bus voltage 40 increases. Thus, regulating the bus voltage 40, in addition to ensuring the safety of the electrical system 4, makes it possible to respond to the power needs of the loads 400. In other words, each of the converters 410, 420, 430 is configured to continuously adjust the power that it injects into or draws from the bus 40, according to the bus voltage 40, so as to respond exactly to the power needs of the loads 400 connected to the bus 40.

This injection into, or this drawing of power from, the bus 40 by the converters 410, 420, 430 is allowed, in particular, by their connection to the electrical sources 411, 421, 431. In fact, at least one, if not each, of the AC generators 411, 421 is connected to a rotary spool BP, HP, of the engine 2 in order to enable an exchange of mechanical and/or electrical power between the rotary spool BP, HP and the AC generator 411, 421, preferably to draw a mechanical power from the rotary spool BP, HP and transform it into an electrical power, which electrical power is then delivered to the first converter 410 and/or to the second converter 420 in order to be injected into the bus 40. Since the electrical power supplied by the AC generators 411, 421 is in the form of an AC signal, each of the first converter 410 and the second converter 420 is configured to reversibly transform this AC signal into a DC signal suitable for being injected into, and then circulated on, the bus 40. Similarly, the DC source 431 can deliver power in the form of a DC signal to the third converter 430, which will still, reversibly, convert it, in order to shape it according to the constraints specific to the bus 40, then inject it into the bus 40. Each, or at least one, of the AC generators 411, 421 can, for example, be a wound rotor synchronous machine, typically comprising three stages, called a variable frequency generator (VFG), driven by at least one among the high-pressure shaft 282 and the low-pressure shaft 280 of the engine 2, typically by means of the accessory gearbox. Other types of electric machines are possible, such as preferably, permanent-magnet synchronous machine drives called PMSM which have the advantage, in particular, of having a more reduced mass, or such as induction machines or variable reluctance machines. Preferably, the first AC generator 411 is connected to the spool HP, while the second AC generator 421 is connected to the spool BP, 280. The DC source 431 can comprise a battery, a supercapacitor, a DC generator and/or a fuel cell. The DC source 431 makes it possible, in particular, to relieve the rotary spools BP, HP, or take over their relays when, for example, the level of drawing required to respond to the power needs of the loads 400 is too high, but also makes it possible to absorb certain dynamics, such as sudden variations in the behaviour of the loads 400.

FIG. 3 also shows that the electrical system 4 comprises a control device 412, 422, 432, 4000, connected to at least one, if not each, of the converters 410, 420, 430.

The control device 412, 422, 432, 4000 illustrated in FIG. 3 comprises a central member 4000 and a plurality of control members 412, 422, 432, each of the control members 412, 422, 432 being connected to (or incorporated in) one of the converters 410, 420, 430. Alternatively, the control device 412, 422, 432 may comprise only the plurality of control members 412, 422, 432, each of the control members 412, 422, 432 being connected to (or incorporated in) one of the converters 410, 420, 430.

The control device 412, 422, 432, 4000 is also advantageously configured to receive a signal V representative of a voltage measurement of the bus 40. In order to do this, the control device 412, 422, 432, 4000 may be connected to the bus 40 or to a voltage sensor connected to the bus 40, and receive from the bus 40 (or from this sensor) the signal V. This signal V can be received via a physical or wireless connection. This signal V represents, in particular, the change in power needs of the part of the loads 400 connected to the bus 40. Typically, when a load 400 suddenly needs to be able to draw a large power from the bus 40, because of the response time of the electrical system 4 in order to supply the bus 40 with the power necessary to compensate the drawn power, the bus voltage 40 will drop abruptly, and this drop will be reported to the control device 412, 422, 432, 4000 via the signal V. In the same way, when a load 400 suddenly sheds a significant amount of power on the bus 40, due to the response time of the electrical system 4 to draw the necessary power from the bus 40 with a view to compensating this shedding, the bus voltage 40 will suddenly increase, and this increase will be reported to the control device 412, 422, 432, 4000 via the signal V. Therefore, the signal V is typically a time signal, in other words providing (or representing) the change in the bus voltage 40 as a function of time. A large number of loads 400, in particular the so-called “active” loads 400, can have this type of dynamic behaviour, which may furthermore vary during the various flight phases.

The changes in the bus voltage 40 are compensated by the action of the converters 410, 420, 430, which action therefore follows the change in the voltage, however sudden and fluctuating it may be. This is why this action is coordinated by the control device 412, 422, 432, 4000 in order to maintain the bus voltage 40 within the margins enabling stable operation of the electrical system 4.

To do this, each of the converters 410, 420, 430 receives, from the control device 412, 422, 432, 4000 a command signal CTRL_1, CTRL_2, CTRL_3 which is specific to it, and on the basis of which the converter 410, 420, 430 regulates the bus voltage 40. The combination of the voltage regulations of each converter 410, 420, 430 thus makes it possible to continuously monitor the power needs of the loads 400.

In the electrical system 4 illustrated in FIG. 3, it is the central member 4000 which is, in particular, configured to receive and then process the signal V. In addition, the central member 4000 is configured to transmit, to each of the control members 412, 422, 432 a command signal CTRL_1, CTRL_2, CTRL_3, typically able to have the form of a command current, for controlling the converters 410, 420, 430. In the electrical system 4 illustrated in FIG. 3, the control is therefore carried out in a centralised manner. Alternatively, when the control device 412, 422, 432 only comprises the control members 412, 422, 432, each of the control members 412, 422, 432 is configured in order, in particular, to receive and process the signal V, and to control the converter 410, 420, 430. In other words, the control is then carried out in a decentralised manner.

FIG. 3 additionally shows the presence of a general controller 7, which can for example be all or part of the system producing the interface between the cockpit of the aircraft 100 and the engine 2 (or FADEC or “Full Authority Digital Engine Control”), typically being the control unit for the engine 2, (or ECU for “Electronic Control Unit”), which is incorporated in the FADEC. The general controller 7 is connected to the control device 412, 422, 432, 4000, in this case to the central member 4000, but could alternatively be connected directly to each of the control members 412, 422, 432 when the central member 4000 is not present. In this case, the functions carried out by the central member 4000 are either performed locally in the control members 412, 422, 432, or performed by the general controller 7. The general controller 7 provides, in particular, the data DFP relating to the natural frequencies of the rotary spools BP, HP, but also the additional constraints to be respected by the electrical system 4 in order to respond to the power needs of the loads 400. Thus, the general controller 7 may transmit, to the control device 412, 422, 432, 4000, an instruction Cons for distributing drawing between the rotary spools BP, HP and the DC source 431, and/or a maximum drawing threshold Se1, Se2, Se3 on at least one, if not each, of the rotary spools BP, HP and the DC source 431, the threshold Se1, Se2, Se3 being, where appropriate, specific to each rotary spool BP, HP and to the DC source 431. More precisely, the distribution instruction Cons indicates to the control device 412, 422, 432, 4000 the way in which the totality of the power to be drawn from the engine 2 in order to respond to the needs of the loads 400 must be distributed between the rotary spools BP, HP, and the DC source 431, and can typically take the form of a percentage. The drawing thresholds Se1, Se2, Se3 provide, for their part, and for each of the electrical sources 411, 421, 431, the maximum value of the power that the control device 412, 422, 432, 4000 is authorised to draw by their respective converter 410, 420, 430; in other words a first maximum value of power can be drawn from the engine 2 by the first converter 410, via the first AC generator 411, a second maximum value of power that can be drawn from the engine 2 by the second converter 420, via the AC second generator 421, and a third maximum value of power able to be drawn from the DC source 431 by the third converter 430. The threshold Se3 associated with the DC source 431 can typically take the form of a charge or discharge current drawing limit if the DC source 431 is a battery. The control device 412, 422, 432, 4000 is then configured to control the converters 410, 420, 430 as a function of the DFP data relating to the natural frequencies of the rotary spools BP, HP, of this distribution instruction Cons and/or of these thresholds Se1, Se2, Se3.

The data DFP relating to the natural frequencies of the rotary spools BP, HP, the distribution instruction Cons and/or the thresholds Se1, Se2, Se3 for drawing transmitted by the general controller 7 can change over time and make it possible to ensure that each of the rotary spools BP, HP and the DC source 431 provide the necessary power to the loads by optimising the operating point of the engine 2. In any event, these data DFP relating to the natural frequencies of the rotary spools BP, HP, this distribution instruction Cons and/or these thresholds Se1, Se2, Se3 for drawing can prove necessary in the case where the mechanical drawing has different consequences according to the rotary spool BP, HP from which the power is drawn.

### Control method

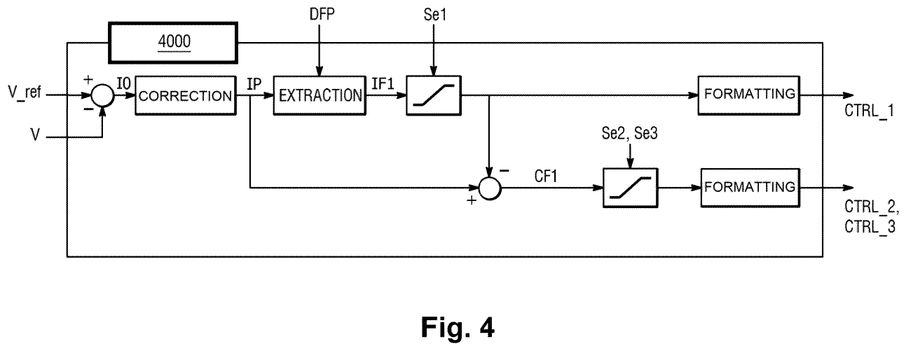

FIG. 4 to FIG. 10 illustrate different embodiments of a control method of the electrical system 4, which method is implemented by the control device 412, 422, 432, 4000 illustrated in FIG. 3, and this in order to allow to respond in real-time to the power needs of the electrical loads 400, whatever the operating phase of the engine 2, while respecting the constraints specific to the engine 2, and in particular to its rotary spools BP, HP.

This control method aims to prevent the stress (i.e., the mechanical drawing by the AC generators 411, 421) of the rotary spools BP, HP, in particular of the shafts 280, 282, in their natural modes, typically in torsion and/or in bending. These natural modes are associated with the natural frequencies and have the peculiarity of accumulating the mechanical energy so as to potentially drive vibrations which are able to damage the parts concerned. Through the control method, the electrical system 4 does not stress, for example by torque, the rotary spools BP, HP at frequencies close to these natural frequencies. To do this, as will be described in detail below, the control method allows the unwanted frequency content drawn from one rotary spool BP, HP to be switched to another electrical source 411, 421, 431, which makes it possible to maximise the power drawn by the electrical system 4 on the rotary spools BP, HP, without however risking reducing their service life. FIG. 4 to FIG. 10 illustrate this control method implemented in the central member 4000, but this is however not limiting since this control method can be implemented in one, if not each, of the control members 412, 422, 432. If this case, the control members 412, 422, 432 are able to exchange information between them, in the form of cabled or remote signals, and/or to receive information from the bus 40 and/or from the general controller 7.

This control method enables the electrical system 4 to correct a difference (or error) detected between a reference V_ref, which depends on the voltage margin of the bus 40, represents the state in which the bus 40 should be for normal operation and can be transmitted by the general controller 7, and a voltage measurement of the bus 40, which represents the reality of the needs of the electrical loads 400 as they are expressed by injecting power into or drawing power from the bus 40. In other words, this control method, by correcting this difference between the reference V_ref and the voltage measurement of the bus 40, ensures that the power needs of the electrical loads 400 are met by voltage regulation of the bus 40.

More precisely, as can be seen in FIG. 4 to FIG. 10, a voltage signal V is received representative of a voltage measurement of the bus 40. This voltage signal V can then be compared with the reference V_ref. If there is no difference between the reference V_ref and the voltage signal V, this means that the bus voltage 40 has not been regulated. By contrast, if a difference is observed, in other words if the bus voltage 40 has undergone a change, it is necessary that the bus voltage 40 is regulated. To do this, it is necessary to control the electrical sources 411, 421, 431, with a view to producing this voltage regulation. This control may, for example, consist of transmitting a command current, a command power or even a command torque. These command signals CTRL_1, CTRL_2, CTRL_3 will determine the manner in which the electrical system 4, and more precisely the electrical sources 411, 421, 431, will have to adjust its operation in order to arrive at this voltage regulation. In this case, an initial command signal 10, easier to manipulate by the control member, whether it is the central member 4000 or the control members 412, 422, 432, may advantageously be generated and then processed according to the error noted in the voltage signal V relative to the reference V_ref. The processing can advantageously be implemented by a proportional integrator corrector. From there, a main signal IP for commanding drawing of a mechanical power by the electrical system 4 on the electrically hybridised engine 2 is ready to reach the electrical system 4. This main command signal IP is representative of the correction to be applied by the electrical system 4 in order to reduce, or even cancel, the difference between reference V_ref and measured signal, and thus to compensate the change in bus voltage 40. However, this main command signal IP only sets the general instruction to be adopted by the electrical system 4, without discriminating between the roles that each of the members of the electrical system 4, and more precisely the electrical sources 411, 421, 431, will have to play in the voltage regulation of the bus 40.

For this purpose, with reference to FIG. 4, the main command signal IP is processed so as to extract from it a first frequency component CF1 corresponding to a natural frequency of a first rotary spool, for example the spool HP, and to generate a first filtered main signal IF1 without the first frequency component CF1. To do this, use can be made, for example, of a band-stop filter or of a low-pass filter, or even a plurality of band pass and/or low-pass filters combined and/or associated with one another. These filters can be of several types or orders. The filters can be of fixed structures, or to have a variable topology as a function of several parameters associated with the data DFP relating to the natural frequencies of the rotary spools BP, HP, for example: the engine speed 2, at least one of the fuel flow in the combustion chamber 24, the position of variable geometries, the flight conditions of the aircraft 100, the level of drawing of mechanical power from the rotary spools BP, HP, etc. In this way, it is possible to take account of potential changes in the natural modes of the rotary spools BP, HP in operation, and to adjust the exclusion of the first frequency component CF1 as a consequence.

From there, a first subsidiary signal CTRL_1 for commanding drawing of a mechanical power by the electrical system 4, and more precisely by the first AC generator 411, from the first rotary spool HP is generated based on the filtered first main signal IF1. This generating of the first subsidiary command signal CTRL_1 can simply consist of formatting the first filtered main signal IF1 in order that it corresponds to the specific constraints of the control member 412 associated with the first AC generator 411. Alternatively, or in addition, as can be seen in FIG. 4, this generation can also be implemented based on the first authorised maximum threshold for drawing Se1 from the first rotary spool HP, which can, likewise, typically be transmitted by the general controller 7. The first subsidiary command signal CTRL_1 therefore corresponds to the command signal transmitted to the control member 412 of the converter 410 connected to the first AC generator 411 drawing a power from the first rotary spool HP.

Furthermore, a second subsidiary signal CTRL_2 for commanding drawing of power by the electrical system 4 from an auxiliary power source BP, 431 is generated based on the first frequency component CF1. Thus, the troublesome natural frequencies for the first rotary spool HP, which were contained in the main command signal IP, are rejected on the auxiliary power source BP, 431. Here again, the generation of the second subsidiary command signal CTRL_2, CTRL_3 can simply consist of formatting the first frequency component CF1 so that it corresponds to the specific constraints of the control member 422, 432 associated with the auxiliary power source BP, 431. Alternatively, or in addition, this generation can also be implemented based on a maximum authorised drawing threshold Se2, Se3 from the auxiliary power source BP, 431, which can, likewise, typically be transmitted by the general controller 7. The auxiliary power source BP, 431 can be a second rotary spool, typically the spool BP, of the engine 2 but can likewise be the DC source 431. The second subsidiary command signal CTRL_2, CTRL_3 therefore corresponds to the command signal transmitted to the control member 422 of the converter 420 connected to the second AC generator 421 drawing a power from the second rotary spool BP or to the control member 432 of the converter 430 connected to the DC source 431.

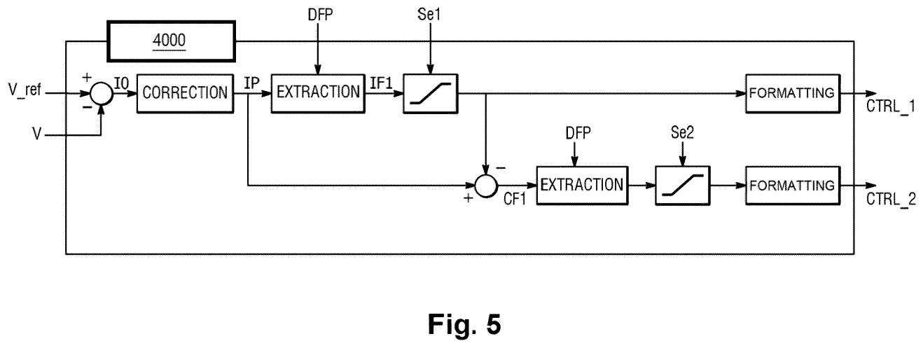

FIG. 5 illustrates that, in the case where the auxiliary power source BP, 431 is a second rotary spool BP of the engine 2, the generation of the second subsidiary command signal CTRL_2 may comprise filtering of the first frequency component CF1 so as to extract from it a second frequency component CF2 corresponding to a natural frequency of the second rotary spool BP. In this way, it is ensured that the troublesome frequency content for the first rotary spool HP, which is rejected on the second rotary spool BP, does not contain any troublesome natural frequencies for the second rotary spool BP either. Here again, the exclusion of the second frequency component CF2 can be implemented on the basis of data DFP relating to the natural frequencies of the rotary spools BP, HP, for example transmitted by the general controller 7, using filters equivalent to those already disclosed.

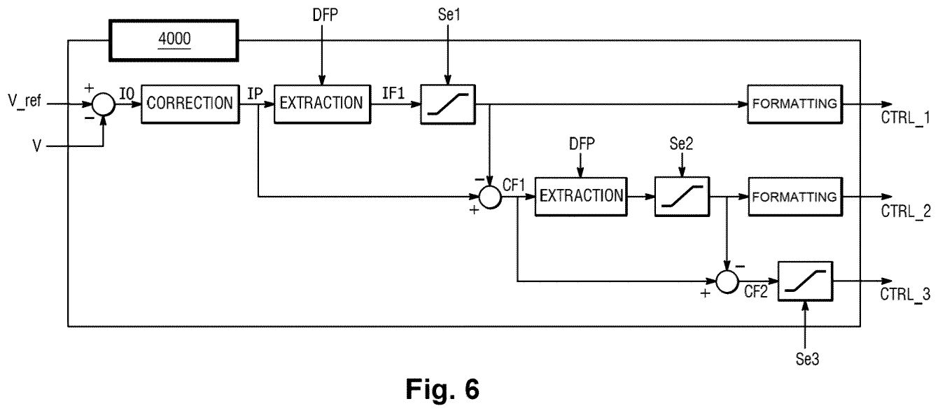

FIG. 6 illustrates that a third subsidiary signal CTRL_3 for commanding drawing an electrical power from the DC source 431 can be generated based on the second frequency component CF2. The third subsidiary command signal CTRL_3 therefore corresponds to the command signal transmitted to the control member 432 associated with the converter 430 connected to the DC source 431. Thus, the troublesome natural frequencies for the second rotary spool BP, which were contained in the first frequency component CF1, are rejected on the DC source 431. Here too, the generation of the third subsidiary command signal CTRL_3 can be implemented based on a maximum authorised drawing threshold Se3 from the DC source 431, which can, likewise, typically be transmitted by the general controller 7. Through this alternative embodiment, almost all the power required via the main signal IP will be effectively drawn by the electrical system 4 from the electrical sources 411, 421, 431, which makes it possible to optimise the performance of the electrical system 4 for the voltage regulation.

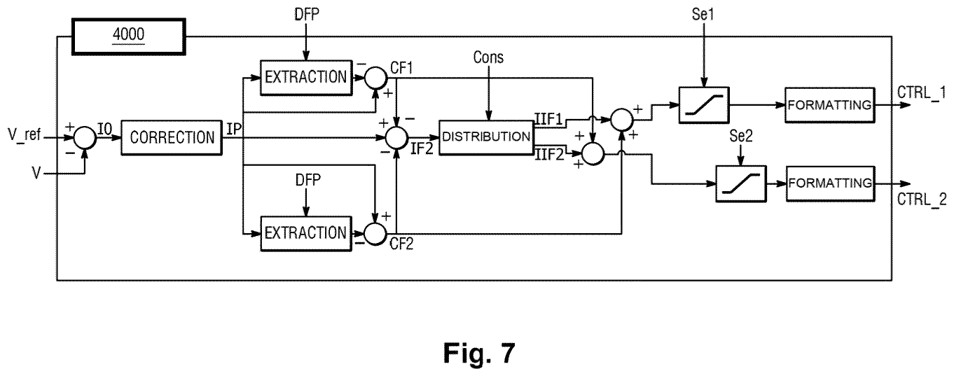

Various alternatives of the control method are illustrated in FIG. 7 to FIG. 10, in which the distribution instruction Cons for distributing drawing between the rotary spools BP, HP and the DC source 431 is used.

FIG. 7 illustrates an alternative of the embodiment illustrated in FIG. 4, in which the auxiliary power source BP, 431 is a second rotary spool BP of the engine 2. It can be seen in FIG. 7, that the main signal IP is likewise processed so as to extract from it a second frequency component CF2 corresponding to a natural frequency of the second rotary spool BP and to generate a second filtered main signal IF2 without the second frequency component CF2. The second filtered main signal IF2 is then processed based on the distribution instruction Cons for distributing drawing of mechanical power between the first rotary spool HP and the second rotary spool BP so as to generate a filtered first intermediate signal IIF 1 for commanding drawing of mechanical power by the electrical system 4 from the first rotary spool HP and a filtered second intermediate signal IIF2 for commanding drawing of mechanical power by the electrical system 4 from the second rotary spool BP. From there, the first subsidiary command signal CTRL_1 is generated both from the second frequency component CF2 and from the filtered first intermediate signal IIF1. Similarly, the second subsidiary command signal CTRL_2 is generated, in addition from the first frequency component CF1 as already described with reference to FIG. 4, of the filtered second intermediate signal IIF2. Thus, the second filtered main signal IF2 is freed from troublesome frequency contents for the two rotary spools BP, HP, which makes it possible to ensure that the second filtered main signal IF2, which is processed by the distribution instruction Cons for distributing drawing of mechanical power between the first rotary spool HP and the second rotary spool BP, is secure. In addition, in order to ensure a maximum performance, the troublesome frequency contents for one of the rotary spools BP, HP are reincorporated in the command signal of the control member 412, 422 associated with the converter 412, 422 connected to the AC generator 411, 421 of the other of the rotary spools BP, HP, and vice-versa. Here too, the generation of the first subsidiary command signal CTRL_1 and, respectively, the second subsidiary command signal CTRL_2 can simply consist of formatting the filtered first intermediate command signal IIF1 and, respectively, the generation of the filtered second intermediate command signal IIF2, in order that it corresponds to the specific constraints of the control members 412, 422 associated with the converter 412, 422 connected to the AC generators 411, 421. Alternatively, or in addition, this generation can also be implemented based, respectively, on the first maximum authorised drawing threshold Se 1 from the first rotary spool HP and on the second maximum authorised drawing threshold Se2 from the second rotary spool BP, which can, likewise, typically be transmitted by the general controller 7.

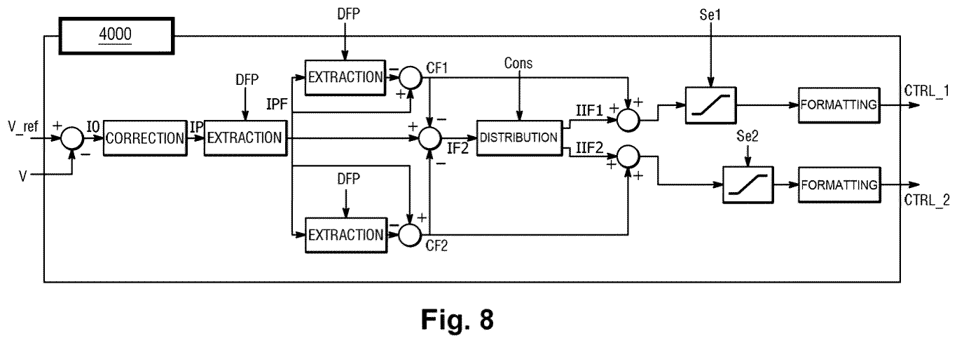

FIG. 8 illustrates a variant similar to the embodiment illustrated in FIG. 7, except that the troublesome frequency contents common to the rotary spools BP, HP are filtered beforehand. More specifically, such frequency contents cannot be rejected on either of the rotary spools BP, HP. More precisely, the main signal IP is processed beforehand so as to extract from it at least a third frequency component CF3 corresponding to a natural frequency common to the first rotary spool HP and to the second rotary spool BP and so as to generate a filtered main intermediate signal IP, wherein the extraction of the at least one of the first frequency component CF1 and the second frequency component CF2 is implemented by processing the filtered main intermediate signal IP. Here again, the exclusion of the third frequency component CF3 can be implemented on the basis of data DFP relating to the natural frequencies of the rotary spools BP, HP, for example transmitted by the general controller 7, using filters equivalent to those already disclosed.

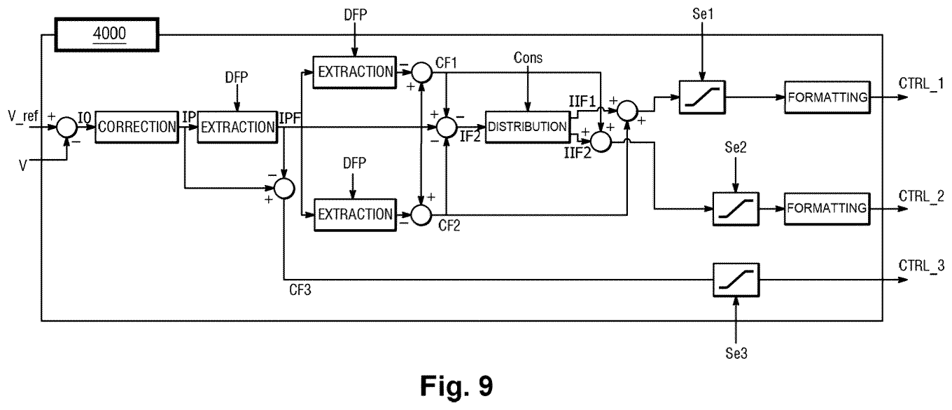

FIG. 9 illustrates a variant of the embodiment illustrated in FIG. 8, wherein this troublesome frequency content common to the two rotary spools BP, HP is rejected to the DC source 431, in order to avoid a loss of power and thus to improve the voltage regulation performance. More precisely, a third subsidiary command signal CTRL_3 for commanding drawing of an electrical power by the electrical system 4 from a DC source 431 is generated based on the extracted third frequency component CF3. Here again, the generation of the third subsidiary command signal CTRL_3 may be implemented based on a maximum authorised drawing threshold Se3 from the DC source 431, which may, likewise, typically be transmitted by the general controller 7.

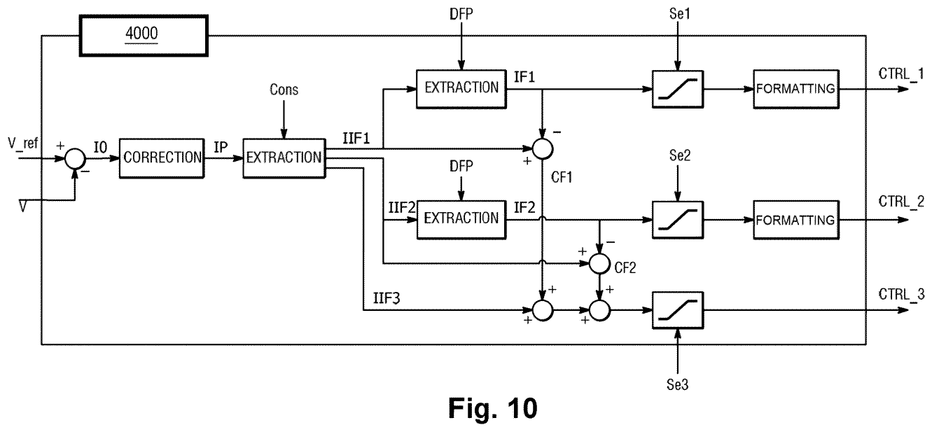

FIG. 10 illustrates a variant of the embodiment illustrated in FIG. 4, in which all the troublesome frequency contents are rejected to the DC source 431, rather than sending them to the other rotary spool HP, BP. More precisely, the auxiliary power source BP, 431 is a second rotary spool BP of the engine 2 and the main signal IP is processed so as to extract from it a second frequency component CF2 corresponding to a natural frequency of the second rotary spool BP and to generate a second filtered main signal IF2 without the second frequency component CF2. In addition a third subsidiary command signal CTRL_3 for commanding drawing of an electrical power by the electrical system 4 from a DC source 431 is generated based on the first frequency component CF1 and the second frequency component CF2. Here again, the generation of the third subsidiary command signal CTRL_3 can be implemented based on the maximum authorised drawing threshold Se3 from the DC source 431, which may, likewise, typically be transmitted by the general controller 7. Similarly, the exclusion of the second frequency component CF2 may be implemented on the basis of data DFP relating to the natural frequencies of the rotary spools BP, HP, for example transmitted by the general controller 7, using filters equivalent to those already disclosed.

FIG. 10 likewise illustrates that the instruction Cons for distributing drawing power between the first rotary spool HP, the second rotary spool HP and the DC source 431 may likewise be used. More precisely, the main command signal IP is processed beforehand based on the instruction Cons for distributing drawing of power between the first rotary spool HP, the second rotary spool BP and the DC source 431, so as to generate a filtered first intermediate signal IIF1 for commanding drawing of a mechanical power by the electrical system 4 from the first rotary spool HP, a filtered second intermediate signal IIF2 for commanding drawing of a mechanical power by the electrical system 4 from the second rotary spool BP and a filtered third intermediate signal IIF3 for commanding drawing of an electrical power by the electrical system 4 from the DC source 431. In addition, the extraction of the first frequency component CF1 is implemented by processing the filtered first intermediate signal IIF1, the extraction of the second frequency component CF2 is implemented by processing the filtered second intermediate signal IIF2 and the generation of the third subsidiary command signal CTRL_3 is implemented based on the filtered third intermediate signal IIF3.

In any event, and as can be seen in FIG. 3, each converter 410, 420, 430 is controlled by its respective control member 412, 422, 432, using the subsidiary command signal CTRL_1, CTRL_2, CTRL_3 which is specific to it, in order to compensate for its part of the voltage change.

### Advantages Obtained

Through the above-described control method, the mechanical drawing of power from the electrically hybridised engine 2 does not risk exciting the natural modes of the shafts 280, 282 of the engine 2, while minimising the losses in power, and therefore in performance, associated with the exclusion of these natural modes in the implementation of the drawing of power.

1-10. (canceled)

11. A method comprising:
processing a main signal for commanding drawing of a main mechanical power by an electrical system from a gas turbine engine so as to extract from the main signal a first frequency component corresponding to a first natural frequency of a first rotary spool of the gas turbine engine, and so as to generate a filtered first signal without the first frequency component;
generating a first subsidiary signal for commanding drawing of a first mechanical power by the electrical system from the first rotary spool based on the filtered first signal; and
generating a second subsidiary signal for commanding drawing of an auxiliary power by the electrical system from an auxiliary power source based on the first frequency component.

12. The method of claim 11, wherein the auxiliary power source is a second rotary spool of the gas turbine engine, and
wherein generating the second subsidiary signal comprises filtering the first frequency component so as to extract from it a second frequency component corresponding to a second natural frequency of the second rotary spool.

13. The method of claim 11, wherein the auxiliary power source is a second rotary spool of the gas turbine engine,
wherein the method further comprises:
processing the main signal so as to extract from it a second frequency component corresponding to a second natural frequency of the second rotary spool, and so as to generate a filtered second signal without the second frequency component;
processing the filtered second signal based on an instruction for distributing drawing of mechanical power between the first rotary spool and the second rotary spool so as to generate a filtered first intermediate signal for commanding drawing of a first intermediate mechanical power by the electrical system from the first rotary spool, and a filtered second intermediate signal for commanding drawing of a second intermediate mechanical power by the electrical system from the second rotary spool;
wherein generating the first subsidiary signal is implemented based on the second frequency component and the filtered first intermediate signal; and
wherein generating the second subsidiary signal is implemented based on the filtered second intermediate signal.

14. The method of claim 11, wherein the auxiliary power source is a second rotary spool of the gas turbine engine,
wherein the method further comprises a prior processing of the main signal so as to extract from the main signal at least one third frequency component corresponding to a third natural frequency common to the first rotary spool and to the second rotary spool, and so as to generate a filtered main intermediate signal,
wherein extracting at least one of the first frequency component and the second frequency component is implemented by processing the filtered main intermediate signal.

15. The method of claim 14, further comprising generating a third subsidiary signal for commanding drawing of an electrical power by the electrical system from a DC source based on the third frequency component.

16. The method of claim 11, wherein the auxiliary power source is a second rotary spool of the gas turbine engine,
wherein the method further comprises:
processing the main signal so as to extract from the main signal a second frequency component corresponding to a second natural frequency of the second rotary spool, and so as to generate a filtered second signal without the second frequency component;
generating a third subsidiary signal for commanding drawing of an electrical power by the electrical system from a DC source based on the first frequency component and the second frequency component.

17. The method of claim 16, further comprising a prior processing of the main signal based on an instruction for distributing drawing of mechanical power between the first rotary spool, the second rotary spool, and the DC source, so as to generate a filtered first intermediate signal for commanding drawing of a first intermediate mechanical power by the electrical system from the first rotary spool, a filtered second intermediate signal for commanding drawing of a second intermediate mechanical power by the electrical system from the second rotary spool, and a filtered third intermediate signal for commanding drawing of the electrical power by the electrical system from the DC source,
wherein extracting the first frequency component is implemented by processing the filtered first intermediate signal, extracting the second frequency component is implemented by processing the filtered second intermediate signal, and generating the third subsidiary signal is implemented based on the filtered third intermediate signal.

18. The method of claim 11, wherein generating one of the first subsidiary signal and the second subsidiary signal is implemented based on a threshold for maximum authorized drawing from one of the first rotary spool and the auxiliary power source.

19. An electrical system comprising:
an electrical supply bus configured to be connected to at least one load and to supply an electrical power to the load in the form of a DC signal;
a first AC generator configured to be connected to a first rotary spool of a gas turbine engine in order to draw a first mechanical power from the first rotary spool, and transform the first mechanical power into a first electrical power to be transferred to the electrical supply bus;
a second AC generator configured to be connected to a second rotary spool of the gas turbine engine in order to draw a second mechanical power from the second rotary spool, and transform the second mechanical power into a second electrical power to be transferred to the electrical supply bus;
a first converter connecting the first AC generator to the electrical supply bus, and configured to regulate a voltage of the electrical supply bus based on the first electrical power;
a second converter connecting the second AC generator to the electrical supply bus, and configured to regulate the voltage of the electrical supply bus based on the second electrical power; and
a control device connected to the first converter and the second converter, and configured to control the converters so as to compensate a change in the voltage of the electrical supply bus by implementing the method of claim 11.

20. A gas turbine engine comprising:
the electrical system of claim 19;
a first rotary spool connected to the first AC generator of the electrical system; and
a second rotary spool connected to the AC second generator of the electrical system.
